(19) United States
(12) Patent Application Publication
(10) Pub. No.: US 2012/0080978 A1
(43) Pub. Date: Apr. 5, 2012

(54) RADIOACTIVE ISOTOPE ELECTROSTATIC GENERATOR

(76) Inventors: Saade Makhlouf, Ain Saade (LB); Khalil Ezzeddine, Achrafieh (LB)

(21) Appl. No.: 13/215,048

(22) Filed: Aug. 22, 2011

Related U.S. Application Data
(60) Provisional application No. 61/388,561, filed on Sep. 30, 2010.

(51) Int. Cl. G21H 1/02

(52) U.S. Cl. 310/305

(57) ABSTRACT

A radioactive isotope electrostatic generator may include emitter electrodes and collector electrodes. The emitters and collectors may be made of low atomic weight material, and may be formed as a mesh. A radioactive isotope may be homogenously distributed on the emitter electrodes.

### CROSS-REFERENCES TO RELATED APPLICATIONS

This application claims benefit of priority to provisional application No. 61/388,561 filed Sep. 30, 2010.

### BACKGROUND OF THE INVENTION

The present invention generally relates to electrical power sources and more particularly to radioactive isotope electrostatic generators.

Current nuclear batteries may achieve low efficiency using high atomic weight metallic sheets in which a large percentage of particle energy may be lost by attenuation. Current nuclear batteries may achieve short working life due to mechanical stress. As can be seen, there is a need for a radioactive isotope electrostatic generator.

### SUMMARY OF THE INVENTION

In one aspect of the present invention, an apparatus comprises a housing; an electro-conductive support body secured to the housing by an electric insulating material; emitter electrodes attached to the electro-conductive support body; collector electrodes attached to the electro-conductive support body and adjacent to the emitter electrodes; and a radioactive isotope homogenously distributed on the emitter electrodes.

In another aspect of the invention, a generator comprises a cylindrical biological shield housing; a cylindrical electro-conductive support body secured by an electric insulator and contained within the housing; emitter electrodes attached to the electro-conductive support body; and collector electrodes attached to a second electro-conductive support body and adjacent to the emitter electrodes, wherein the emitter electrodes and the collector electrodes are formed of fiber in the form of an emitter mesh and a collector mesh, respectively.

These and other features, aspects and advantages of the present invention will become better understood with reference to the following drawings, description and claims.

### BRIEF DESCRIPTION OF THE DRAWINGS

FIG. 1 illustrates a top view of a radioactive isotope electrostatic generator;

FIG. 2 shows the radioactive isotope electrostatic generator of FIG. 1, with connectors shown adjacent to electrical leads;

FIG. 3 shows a top view of a cylindrical radioactive isotope electrostatic generator;

FIG. 4 shows a front view of an emitter mesh;

FIG. 5 shows a front view of a collector mesh;

FIG. 6 is a cross-sectional view of the cylindrical radioactive isotope electrostatic generator of FIG. 3;

FIG. 7 shows a side view of a set of cylindrical radioactive isotope electrostatic generators; and

FIG. 8 shows a top view of the set of cylindrical radioactive isotope electrostatic generators from FIG. 7.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a radioactive isotope electrostatic generator for producing electrical energy. The radioactive isotope electrostatic generator may be used as a nuclear battery.

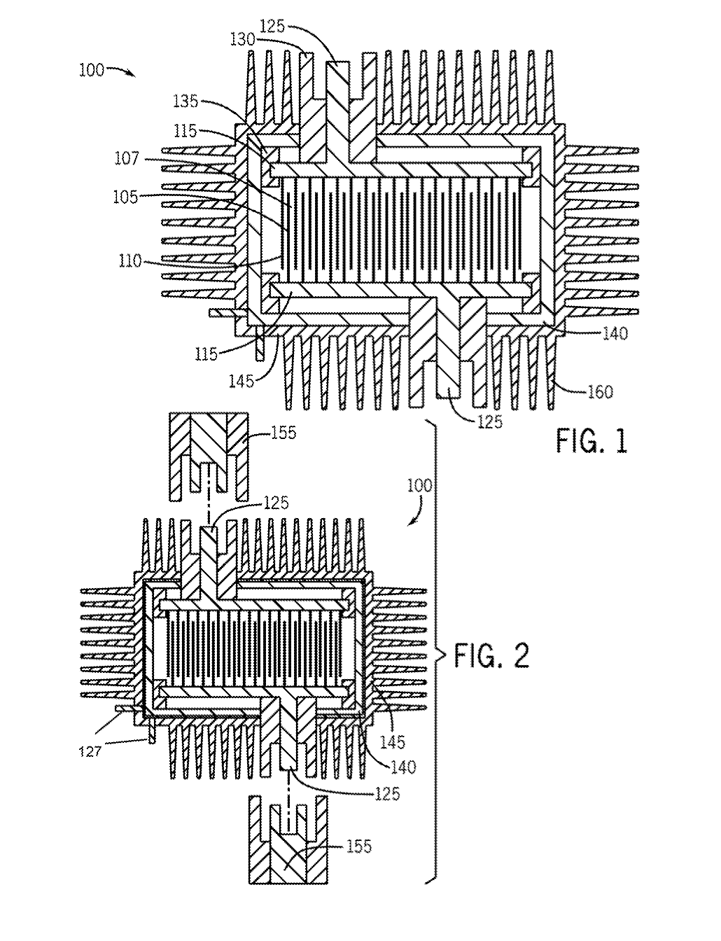

Referring to the drawings, there is shown, in FIGS. 1 and 2, a radioactive isotope electrostatic generator 100, or battery, made in accordance with exemplary embodiments of the present invention. The generator 100 is composed of alternating emitter electrodes 105 and collector electrodes 110. The emitter electrodes 105 may be adjacent to collector electrodes 110, and the emitter electrodes 105 may be separated from the collector electrodes 110 by an evacuated spacing 107 that may be an ideal vacuum or other dielectric insulating material. The emitter electrodes 105 and the collector electrodes 110 may both be connected electrically to electro-conductive supports 115. The electro-conductive supports 115 contained within a housing 140 may be secured with high mechanical strength electric insulating material (fixator) 135 and the electric insulating material 135 may be attached to and contained within the housing 140. The high mechanical strength fixator 135 is attached to both the housing 140 and the electro-conductive supports 115 but it is a dielectric material so the housing 140 is not electrified. Radioactive isotope microparticles or nanoparticles may be homogenously distributed on the emitter electrodes 105. The alpha or beta particles are captured by the collector electrodes 110. The emitter electrodes 105 and collector electrodes 110 are made from a high strength low atomic weight carbon fiber textile or carbon nanotubes textile (mesh) material and more specifically from electro-conductive and thermo-conductive carbon fiber, carbon nanotubes fiber or silicone fiber (wound) in the form of a mesh (Shown in FIG. 4 and FIG. 5 below). The collection of the alpha and/or beta particles by the collector electrodes 110 may produce power in the form of an output voltage as discussed in more detail below. Alpha (α) or Beta (β) particles which are emitted from the emitter electrodes 105 are captured by the collector electrodes 110. This effect generates a high electro-static field between two opposite electrodes, and this can generate electric current when the power load is closed (circuit conducted). Radioactive particles are emitted from the entire surface area of the emitter electrodes 105 in all directions and collected by the collector electrodes 110. The emitter electrodes 105 and collector electrodes 110 may be surrounded by the housing 140 which may be a radio-biological shield housing 140. The radio-biological shield housing 140 may protect the generator 100 from hazards. The system is completely surrounded by a well-sealed case 145. The thickness and properties of the case 145 may vary depending on the type of radioactive isotope source, intended use, years of use and abuse. The housing 140 and the case 145 may serve as nuclear radiation shields to avoid unwanted radiation effects on the surroundings by nuclear radiation sources. Although carbon fiber and carbon nanotubes are important neutron moderators, a thin layer of neutron absorber material (i.e. Hafnium, boron or cadmium) may be inserted within the case 145 structure.

Electrical leads 125 may be disposed on the exterior of the housing 140 in order to connect the generator 100 to an electrical load 127. A connector 155 may connect the electrical lead 125 to the electrical load 127. A high voltage electric isolator 130 may encase the electrical leads 125 and separate it electrically from the housing 140. The high voltage electric isolator 130 may be comprised of materials such as, for example, Teflon, fiberglass composite, or ceramic. The housing 140 and the rest of the generator 100 may be cooled by dispelling heat through the surface area of fins 160 on the case 145. The case 145 may be used as an electrical load or resistor 127. An electrical insulating material 135 of high dielectric strength and high thermal conductivity, such as, for example, mica sheet, may be used to electrically insulate the case 145 from the housing 140.

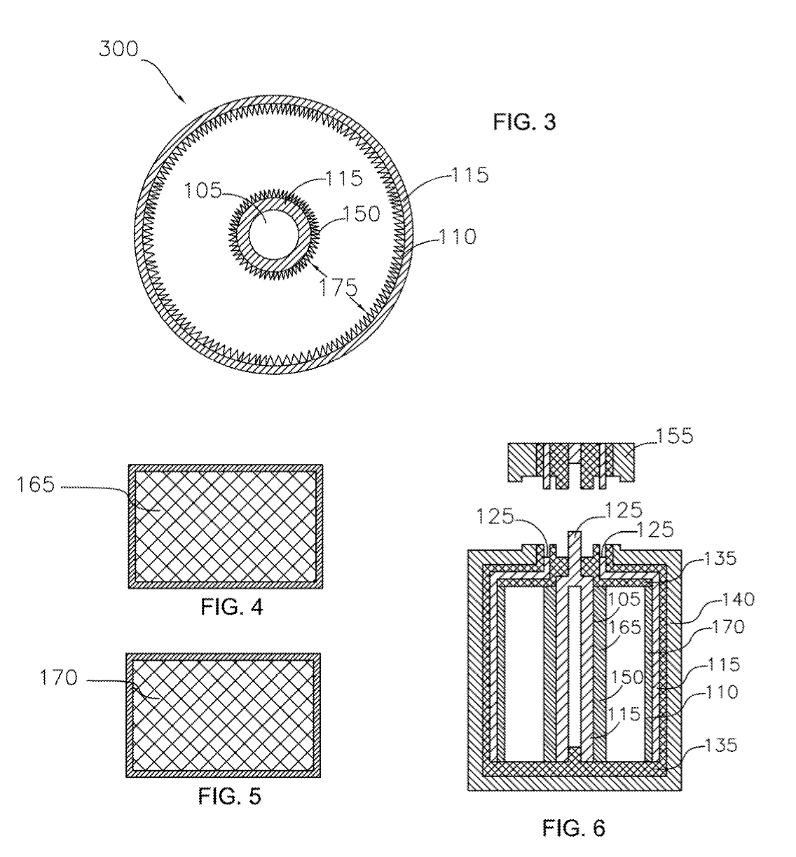

Referring to FIGS. 3, 4, 5, 6, 7, and 8, an exemplary embodiment of the invention is shown in a coaxial cylindrical configuration. In an exemplary embodiment, a cylindrical electrostatic electrical generator 300 may be created. Emitter electrodes 105 and collector electrodes 110 on the cylindrical electrostatic electrical generator 300 may connect to a cylindrical electro-conductive support 115 made of, for example, aluminum, copper or titanium. The emitter electrodes 105 and collector electrodes 110 may be made in the form of an emitter mesh 165 and a collector mesh 170. The electrodes may project from the electro-conductive supports 115 in an alternating sequence to form a mesh array for the emitter mesh 165 and the collector mesh 170. As shown in FIG. 4 and FIG. 5, each mesh is stretched in a frame of a dielectric material i.e. (High strength carbon fiber composite (Epoxy Resin, polyester resins), Aramid fiber composite, M5 fiber composite or fiberglass composite). The frame secures the mesh from all sides and allows the mesh of carbon fiber or carbon nanotubes to be electrically connected to the electro-conductive supports 115 from one side. A connector 155 may connect the electrical lead 125 to the electrical load 127 (shown in FIG. 2). The electrode mesh 165 may be folded as a corrugated sheet onto the electro-conductive supports 115. As an example, openings in the emitter mesh 165 and the collector mesh 170 may represent up to 90% of the surface area of the emitter mesh 165 and the collector mesh 170. Radioactive isotope 150 may be homogenously distributed on the emitter electrodes 105. Output voltage may be based upon the distance 175 between the emitter electrodes 105 and the collector electrodes 110.

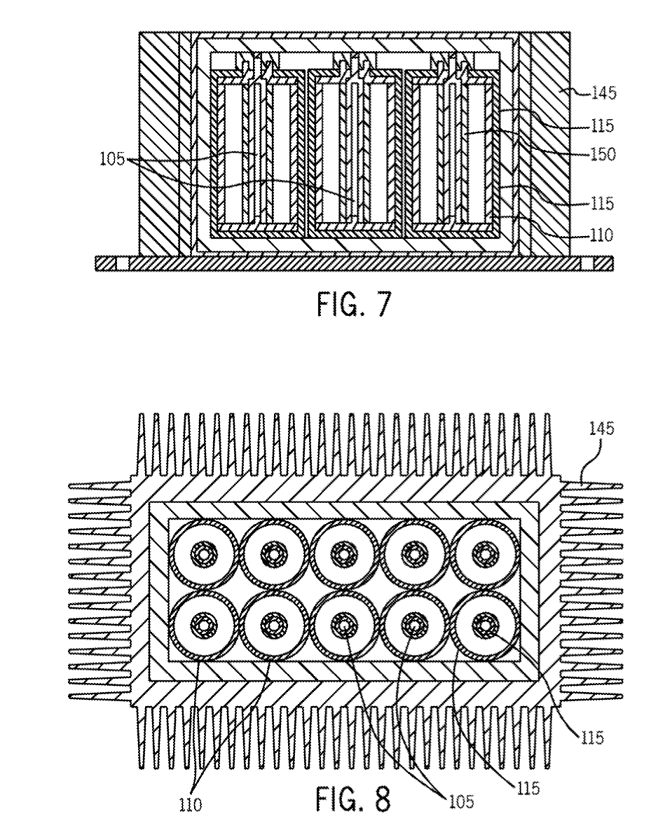

In an exemplary embodiment, an increase in the distance 175 between the emitter electrodes 105 and the collector electrodes 110 may reduce the output voltage. Radioactive isotope 150 may be precipitated on a wide geometric surface nanostructure, and the precipitation of the radioactive isotope 150 on a wide surface may raise efficiency of radioactive isotope 150 decay and may prevent the radioactive isotope 150 from transforming into thermal energy by being attenuated in the emitter electrode itself. As an example, the generator 100 may include electrical generation efficiency of over eighty five percent. A plurality of generators 300 (See FIG. 7 and FIG. 8) may produce a desired power output. In one embodiment a cooling fluid may circulate between a set of generators 300 such that the heat may be dissipated by the case 145.

In an exemplary embodiment of the invention, the emitter electrodes 105 and collector electrodes 110 may be insulated by a vacuum or dielectric insulating material. The utilization of a low atomic weight and high mechanical strength material in constructing the emitter and collector electrodes including carbon fiber or carbon nanotubes may prevent emission of Bremsstrahlung photons as well as it may prevent the attenuation of Alpha or Beta particles in the emitter or collector electrode structure itself. Decay of radioactive materials may produce electrically charged radioactive particles such as alpha and beta particles. Alpha and beta particles may pass from the emitter electrodes 105 to the collector electrodes 110. The passing of the alpha and beta particles from the emitter electrodes 105 to the collector electrodes 110 may generate a high electrostatic field between emitter electrodes 105 and collector electrodes 110, which may generate electric current when a power load is closed. Power output and energy density may depend on the number of emitter electrodes 105 and collector electrodes 110 used, and on the half-life and nature of used radioactive material.

The generator 100 and 300 may deliver power to an external load, such as a resistor, whose value may be chosen to maximize power delivered to the electrical load to yield voltage desired, to control temperature of the generator 100, or a combination of both. A greater number of emitter electrodes 105 and collector electrodes 110 may produce increased power. The emitter electrodes 105 may be electrically connected to each other in parallel. In addition, a greater size of emitter electrodes 105 and collector electrodes 110 may produce increased power. The emitter electrodes 105 and the collector electrodes 110 may be flat or cylindrical. The generator 100 may be surrounded by the case 145, which may be sealed. Thickness and other properties of the case 145 may vary depending on type radioactive isotope 150 source, intended use of the generator 100, years of intended use of the generator, and amount of abuse the generator 100 is expected to endure. The case 145 may serve as a nuclear radiation shield to avoid unwanted radiation effects on surroundings by the generator 100. A thin layer of neutron absorber material such as, for example, hafnium, boron, or cadmium, may be inserted into the case 145 structure for moderating and reflecting neutrons. Carbon fiber and carbon nanotube fibers used to build the meshes also may moderate neutrons.

In an exemplary embodiment of the invention, the electrostatic generator 100 and 300 may be used as a power source for electric vehicles and other transportation, homes, businesses, and as a remote power source. As an example, the generator 100 and 300 may utilize a gamma ray-free radioactive isotope 150 cadmium 113m, which pay have a half-life of fourteen years. Calcium 45 may have a half-life of 0.45 years and may be used as the radioisotope in the construction of the electrostatic generator 100 when used for motor vehicles and other vehicles used for transportation of persons.

In an exemplary embodiment, the electro-conductive supports 115 for the emitter electrodes 105 and collector electrodes 110 may be constructed based on mechanical specification elasticity, tensile strength, yield strength, weld ability, and ability to bond with the emitter electrodes 105 and collector electrodes 110. The electro-conductive supports 115 may be insulated from the external case 145 with a dielectric material. The radioactive isotope 150 may form layers and may be housed in a lead housing to prevent leakage of radiation from the electrostatic generator.

It should be understood, of course, that the foregoing relates to exemplary embodiments of the invention and that modifications may be made without departing from the spirit and scope of the invention as set forth in the following claims.

We claim:

1. An apparatus comprising:
a housing;
an electro-conductive support body secured to the housing by an electric insulating material;
emitter electrodes attached to the electro-conductive support body;
collector electrodes attached to the electro-conductive support body and adjacent to the emitter electrodes; and
a radioactive isotope homogenously distributed on the emitter electrodes.

2. The apparatus of claim 1,
wherein the emitter electrodes and collector electrodes are made of a material selected from the group of low atomic weight material, carbon fiber, carbon nanotubes, and silicone fiber.

3. The apparatus of claim 1,
wherein the emitter electrodes and the collector electrodes are disposed as fibers in the form of an emitter mesh and a collector mesh.

4. The apparatus of claim 2 wherein the electro-conductive support body is cylindrical in shape.

5. The apparatus of claim 3, wherein the electrodes are configured to emit alpha or beta particles.

6. The apparatus of claim 3, wherein the emitter mesh and the collector mesh are configured with openings that represent 90% of the surface area of the emitter mesh and the collector mesh.

7. A generator comprising:
a cylindrical biological shield housing;
a cylindrical electro-conductive support body secured by an electric insulating material and contained within the housing;
emitter electrodes attached to the electro-conductive support body; and
collector electrodes attached to a second electro-conductive support body and adjacent to the emitter electrodes,
wherein the emitter electrodes and the collector electrodes are formed of fiber in the form of an emitter mesh and a collector mesh, respectively.

8. The generator system of claim 7, including
a radioactive isotope microparticles or nanoparticles homogenously distributed on the emitter electrodes.

9. The generator of claim 7 wherein the emitter electrodes are configured to emit alpha or beta particles.

10. The generator of claim 7,
wherein the emitter electrodes and the collector electrodes are comprised of low atomic weight material.

11. The generator of claim 7, wherein the housing comprises a radio-biological shield housing that surrounds the emitter electrodes and the collector electrodes.

12. The generator of claim 11, wherein the radio-biological shield includes a finned case that is configured to dissipate heat.

13. The generator of claim 11 wherein the electro-conductive support body is insulated by a dielectric material from the radio-biological shield housing.

14. The generator of claim 11,
wherein a layer of neutron absorber material is inserted into a case surrounding the housing, and
wherein the emitter electrodes and the collector electrodes are separated from each other by dielectric material.

15. The generator of claim 11, wherein the emitter electrodes and the collector electrodes are separated from each other by a vacuum.
